(19) United States
(12) Patent Application Publication
(10) Pub. No.: US 2022/0201370 A1
(43) Pub. Date: Jun. 23, 2022

(54) SIMULATING AUDIENCE REACTIONS FOR PERFORMERS ON CAMERA

(71) Applicant: Sony Group Corporation, Tokyo (JP)

(72) Inventors: Lindsay Miller, San Diego, CA (US); Thomas Dawson, Escondido, CA (US); Gregory Carlsson, Santee, CA (US); David Young, San Diego, CA (US)

(73) Assignee: Sony Group Corporation, Tokyo (JP)

(21) Appl. No.: 17/127,923

(22) Filed: Dec. 18, 2020

(51) Int. Cl. H04N 21/81; H04N 21/2187; H04N 21/442

(52) U.S. Cl. CPC H04N 21/8126; H04N 21/44218; H04N 21/2187

(57) ABSTRACT

Implementations generally provide simulated audience reactions to performers on camera. In some implementations, a method includes receiving a video of a target user from a target client device. The method further includes providing the video to a plurality of audience client devices. The method further includes receiving raw audience feedback from the plurality of audience client devices. The method further includes providing simulated audience feedback to the target client device based on one or more predetermined audience feedback policies, wherein the target client device provides the simulated audience feedback to the target user.

Live events are increasingly aired online. Live events that are held on online platforms currently do not compare favorably to live events. This is because the performer receives little audience feedback while performing. For example, if a performer tells a specific joke that previously resulted in much laughter in one city (e.g., San Francisco) might not result in positive feedback in another city (e.g., San Atlanta). In a live scenario, the performer may decide to skip similar jokes for the remainder of that performance based on the lack of positive feedback. However, online performances typically provide little to no audience feedback to the performer.

### SUMMARY

Embodiments generally provide simulated audience reactions to performers on camera. In some embodiments, a system includes one or more processors, and includes logic encoded in one or more non-transitory computer-readable storage media for execution by the one or more processors. When executed, the logic is operable to cause the one or more processors to perform operations including: receiving a video of a target user from a target client device; providing the video to a plurality of audience client devices; receiving raw audience feedback from the plurality of audience client devices; and providing simulated audience feedback to the target client device based on one or more predetermined audience feedback policies, wherein the target client device provides the simulated audience feedback to the target user.

With further regard to the system, in some embodiments, the logic when executed is further operable to cause the one or more processors to perform operations comprising: aggregating the raw audience feedback; characterizing the raw audience feedback; and generating the simulated audience feedback based on the characterizing of the raw audience feedback and the one or more predetermined audience feedback policies. In some embodiments, the logic when executed is further operable to cause the one or more processors to perform operations comprising providing simulated audience feedback to the target client device based on the raw audience feedback and the one or more predetermined audience feedback policies. In some embodiments, the simulated audience feedback comprises one or more of visual audience feedback, auditory audience feedback, and haptic audience feedback. In some embodiments, at least one predetermined audience feedback policy of the one or more predetermined audience feedback policies comprises characterizing positive and negative aspects of the raw audience feedback. In some embodiments, at least one predetermined audience feedback policy of the one or more predetermined audience feedback policies comprises characterizing contextual information associated with the video. In some embodiments, the logic when executed is further operable to cause the one or more processors to perform operations comprising providing one or more portions of the simulated audience feedback to the audience client devices based on the one or more predetermined audience feedback policies, wherein the audience client devices provide the one or more portions of the simulated audience feedback to audience users.

In some embodiments, a non-transitory computer-readable storage medium with program instructions thereon is provided. When executed by one or more processors, the instructions are operable to cause the one or more processors to perform operations including: receiving a video of a target user from a target client device; providing the video to a plurality of audience client devices; receiving raw audience feedback from the plurality of audience client devices; and providing simulated audience feedback to the target client device based on one or more predetermined audience feedback policies, wherein the target client device provides the simulated audience feedback to the target user.

With further regard to the computer-readable storage medium, in some embodiments, the instructions when executed are further operable to cause the one or more processors to perform operations comprising: aggregating the raw audience feedback; characterizing the raw audience feedback; and generating the simulated audience feedback based on the characterizing of the raw audience feedback and the one or more predetermined audience feedback policies. In some embodiments, the instructions when executed are further operable to cause the one or more processors to perform operations comprising providing simulated audience feedback to the target client device based on the raw audience feedback and the one or more predetermined audience feedback policies. In some embodiments, the simulated audience feedback comprises one or more of visual audience feedback, auditory audience feedback, and haptic audience feedback. In some embodiments, at least one predetermined audience feedback policy of the one or more predetermined audience feedback policies comprises characterizing positive and negative aspects of the raw audience feedback. In some embodiments, at least one predetermined audience feedback policy of the one or more predetermined audience feedback policies comprises characterizing contextual information associated with the video. In some embodiments, the instructions when executed are further operable to cause the one or more processors to perform operations comprising providing one or more portions of the simulated audience feedback to the audience client devices based on the one or more predetermined audience feedback policies, wherein the audience client devices provide the one or more portions of the simulated audience feedback to audience users.

In some embodiments, a method includes: receiving a video of a target user from a target client device; providing the video to a plurality of audience client devices; receiving raw audience feedback from the plurality of audience client devices; and providing simulated audience feedback to the target client device based on one or more predetermined audience feedback policies, wherein the target client device provides the simulated audience feedback to the target user.

With further regard to the method, in some embodiments, the method further includes: aggregating the raw audience feedback; characterizing the raw audience feedback; and generating the simulated audience feedback based on the characterizing of the raw audience feedback and the one or more predetermined audience feedback policies. In some embodiments, the method further includes providing simulated audience feedback to the target client device based on the raw audience feedback and the one or more predetermined audience feedback policies. In some embodiments, the simulated audience feedback comprises one or more of visual audience feedback, auditory audience feedback, and haptic audience feedback. In some embodiments, at least one predetermined audience feedback policy of the one or more predetermined audience feedback policies comprises characterizing positive and negative aspects of the raw audience feedback. In some embodiments, at least one predetermined audience feedback policy of the one or more predetermined audience feedback policies comprises characterizing contextual information associated with the video.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a block diagram of an example live event environment for providing simulated audience feedback to a performer on camera, which may be used for implementations described herein.

FIG. 2 is a block diagram of another example live event environment 200 for providing simulated audience feedback to a performer on camera, according to some implementations.

FIG. 3 is an example flow diagram for providing simulated audience feedback to a performer on camera, according to some embodiments.

FIG. 4 is an example user interface for providing simulated audience feedback to a performer on camera, according to some implementations.

FIG. 5 is a block diagram of an example network environment, which may be used for some implementations described herein.

FIG. 6 is a block diagram of an example computer system, which may be used for some implementations described herein.

### DETAILED DESCRIPTION

Embodiments described herein enable, facilitate, and manage the providing of simulated audience feedback to performers on camera. Such simulated audience feedback may include visual feedback in the form of visual cues and auditory feedback in the form of sound cues. The simulated audience feedback may indicate various audience reactions to a performance (e.g., cheering, laughing, smiling, clapping, dancing, etc.), where these reactions add to the energy and enjoyment of the event, for both the artist/performer and the audience. The simulated audience feedback provides the performer or target user with social signals, which enable the target user to make decisions with regard to the performance.

As described in more detail herein, in various embodiments, a system receives a video of a target user (performer) from a target client device. The system then provides the video to multiple audience client devices. The system then receives raw audience feedback from the audience client devices. The system then provides simulated audience feedback to the target client device based on one or more predetermined audience feedback policies, where the target client device provides the audience feedback to the target user.

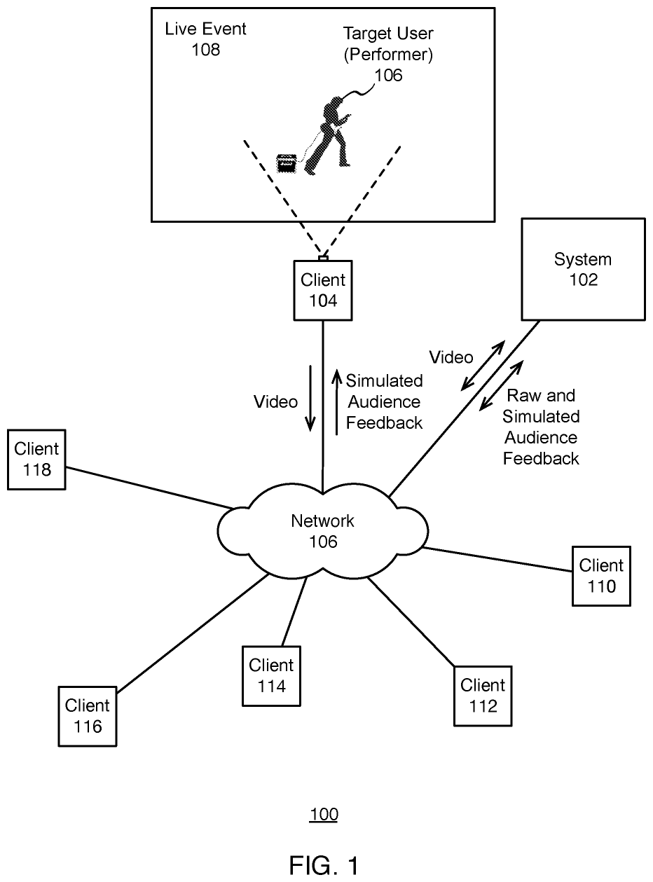

FIG. 1 is a block diagram of an example live event environment 100 for providing simulated audience feedback to a performer on camera, which may be used for implementations described herein. In some implementations, environment 100 includes a system 102, which communicates with a client device 104, or client 104, via a network 106. The terms client device and client may be used interchangeably. Network 106 may be any suitable communication network such as a Bluetooth network, a Wi-Fi network, the Internet, etc.

As described in more detail herein, a camera of client 104 captures a video of target user 106 in an activity area of a live event 108. As shown, client device 104 has an integrated camera. In various embodiments, client device 104 may operate with an integrated camera and/or one or more separate, stand-alone cameras. Live event 108 may include any activity area or environment where target user 106 may perform in front of a camera. For example, live event 108 may be a room, studio, stage, etc. Also live event 108 may be indoors or outdoors. In various embodiments, target user 106 is a performer. The terms target user and performer may be used interchangeably.

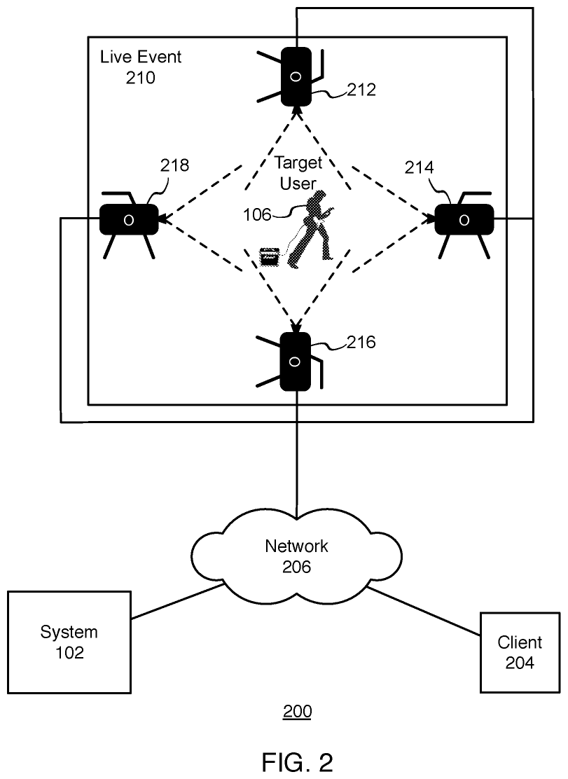

In various embodiments, system 102 receives a video of target user 106 from client devices 104 and then sends or broadcasts the video to an audience via client devices 110, 112, 114, 116, and 118. In various embodiments, the video is streaming live. Each of client devices 110-118 receives the video, which may be viewed by one or more audience members. For example, a given client device may be a computer, smartphone, etc. that displays the video to an individual in a user interface. In another example, a given client device may be an entertainment system that displays the video to an individual or group of individuals on a television, etc. While some embodiments are described herein in the context of a single camera, these and other embodiments may also apply to multiple cameras. Some example embodiments involving multiple cameras are described herein, in connection with FIG. 2, for example.

In various embodiments, system 102 receives raw audience feedback from the audience via their respective client devices 110-118. Client devices 110-118 of the audience members may also be referred to as audience client devices 110-118. In various embodiments, the raw audience feedback may include sound (e.g., laughter, clapping, etc.) and other data (e.g., emoji or other ideogram selections, user-entered text, predetermined text selections, etc.).

As described in more detail herein, system 102 may collect raw audience feedback from the audience in real-time as the audience views the performance. Such raw audience feedback may include audio and video data, which may be collected using microphones and video cameras local to the audience members in association with their respective client devices. For example, a microphone and/or a camera integrated with or accessible by a given audience client device may be utilized. While system 102 enables audience members to provide feedback via audio or video means, in various embodiments, system 102 also enables each audience member opt out of or to turn off any the video recording and/or the audio recording of the audience member.

In various embodiments, system 102 may operate in combination with one or more online platforms, including social networks. For example, system 102 may stream videos via the one or more online platforms. System 102 may also collect raw audience feedback via the one or more online platforms. In various embodiments, system 102 may operate with third-party online platforms.

System 102 may utilize various artificial intelligence techniques, deep machine learning techniques, and computer vision techniques to process the raw audience feedback. Example embodiments directed to the processing of the raw audience feedback are described in more detail herein.

As described in more detail herein, system 102 converts the raw audience feedback to simulated audience feedback. System 102 then provides the simulated audience feedback to client device 104 based on one or more predetermined audience feedback policies. Target user 106 may view or listen to simulated audience feedback on client device 104 during performance, and may adjust the performance accordingly based on the feedback. Client device 104 of target user 106 may also be referred to as target client device 104. Example embodiments directed to the generating of the raw audience feedback are described in more detail herein.

For ease of illustration, FIG. 1 shows one block for each of system 102, client 104, and network 106. Blocks 102, 104, and 106 may represent multiple systems, client devices, and networks. Also, there may be any number of client devices associated with audience members. In other implementations, environment 100 may not have all of the components shown and/or may have other elements including other types of elements instead of, or in addition to, those shown herein.

While system 102 performs embodiments described herein, in other embodiments, any suitable component or combination of components associated with system 102 or any suitable processor or processors associated with system 102 may facilitate performing the embodiments described herein.

FIG. 2 is a block diagram of an example live event environment 200 for providing simulated audience feedback to a performer on camera, according to some implementations. In this example embodiment, environment 200 includes system 102 and target user 106 of FIG. 1. System 102 communicates with a target client device 204 via a network 206. Network 206 may be any suitable communication network such as a Bluetooth network, a Wi-Fi network, the Internet, etc.

In this example embodiment, system 102 receives multiple videos of target user 106 in a live event 210 from multiple cameras 212, 214, 216, and 218 associated with client 104 and system 102. While four cameras are shown, there may be any number of cameras, even a single camera as shown in FIG. 1. While embodiments are described herein in examples where one or more cameras are separate from the client device of the target user, a given camera used to capture video of the target user may be integrated into the client device. For example, the client device may be a computer with a camera, a smartphone with a camera, etc.

In various embodiments, target user 106 may be a performer in that target user 106 performs an activity that is viewed by an audience. The performer may be of various types, and depends on the particular implementation. For example, in various embodiments, the performer is an entertainment performer or performing artist such as a musician, a standup comic, magician, etc. In various embodiments, the performer may be a public speaker such as a teacher, facilitator, leader, etc. As indicated herein, the terms target user and performer may be used interchangeably.

In various embodiments, cameras 212-218 may be positioned at arbitrary locations in live event 210 in order to capture multiple videos at different points of view of target user 106. The terms cameras and video cameras may be used interchangeably. While some embodiments are described in the context of a single video recording, these embodiments and others may also apply to multiple videos. As such, system 102 may broadcast a streaming video that may include multiple videos. The particular configuration of the streaming video may vary, depending on the implementation. For example, the streaming video may include multiple videos concatenated in series and/or multiple videos on a split screen, etc.

For ease of illustration, FIG. 2 shows one block for each of system 102, client device 204, and network 206. Blocks 102, 204, and 206 may represent multiple systems, client devices, and networks. Also, there may be any number of cameras in live event 210. In other implementations, environment 200 may not have all of the components shown and/or may have other elements including other types of elements instead of, or in addition to, those shown herein.

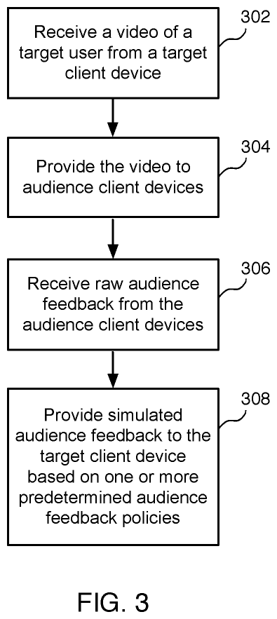

FIG. 3 is an example flow diagram for providing simulated audience feedback to a performer on camera, according to some embodiments. Referring to both FIGS. 1 and 3, a method is initiated at block 302, where a system such as system 102 receives a video of a target user from a target client device, such as client device 104. In various embodiments, the video my include video footage from one or more cameras. The video footage from the multiple cameras may be combined into a single video at system 102 and/or client device 204.

At block 304, system 102 provides the video to multiple audience client devices. System 102 may stream the video via any suitable online platform, including a social media platform. System 102 may also stream the video via any suitable third-party social media platforms.

At block 306, system 102 receives raw audience feedback from the plurality of audience client devices. In various embodiments, system 102 may detect natural visual feedback or body language that different audience members do during a performance (e.g., smiling, leaning forward, frowning, etc.). System 102 may detect natural auditory feedback that different audience members do during a performance (e.g., chuckling, laughing, booing, etc.). As indicated above, system 102 may collect raw audio data using microphones and raw video data using video cameras. Such microphones and video cameras are local to the audience in association with their respective client devices.

Because many audience members may view a given online performance alone or with a small group at home, the audience feedback from a given client device may be different and less intense than audience feedback from a large group of audience members who are physically at the live event.

As described in more detail herein, in various embodiments, system 102 collects and processes subtle and non-so-subtle audience feedback and repackages or generates simulated audience feedback to be provided to the target user/performer 106 via a client device. As the raw audience feedback may include positive and negative feedback, system 102 indicates such positive and/or negative feedback in the simulated audience feedback. Example embodiments directed to the processing of raw audience feedback are described in more detail in connection with block 308 below, for example.

In some embodiments, system 102 may collect other types of audience feedback from the audience. For example, system 102 may enable audience members to make user-selections in a user interface to give feedback to the target user/performer. In another example, the user interface may include audience sentiment selections, which may include emoji icons (e.g., smiley face, heart, etc.) or predetermined messages (e.g., “Love this!,” “Encore!,” etc.) for an audience member to tap. In some embodiments, system 102 may enable audience members to free type messages to give feedback to the target user/performer (e.g., in a chat window, etc.).

At block 308, system 102 provides simulated audience feedback to the target client device based on one or more predetermined audience feedback policies. In various embodiments, target client device provides the simulated audience feedback to the target user/performer.

In various embodiments, system 102 generates the simulated audience feedback based on the characterizing of the raw audience feedback and the one or more predetermined audience feedback policies. In various embodiments, audience feedback policies facilitate in generation of the simulated audience feedback to be sent to target user 106. Various example embodiments directed to audience feedback policies are described in more detail below.

In various embodiments, system 102 determines from the raw audience feedback mixed reactions from different audience members. For example, system 102 may determine how many people are clapping, how many people are cheering, how many are booing, etc. In various embodiments, system 102 may classify or categorize each type of feedback as positive or negative. For example, system 102 may deem laughter as positive and boos as negative. The enables system 102 to provide meaningful simulated audience feedback that represents reactions and sentiments of the audience. For example, system 102 may play cheering louder than booing if system 102 determines that more people are cheering and only a few people are booing. As such, system 102 converts or translates raw audience feedback into simulated audience feedback that closely represents the actual feedback of the audience in general. In some embodiments, system 102 may show a number of audience members viewing the performance and a number or percentage of audience members who are taking a particular action (e.g., laughing, applauding, etc.).

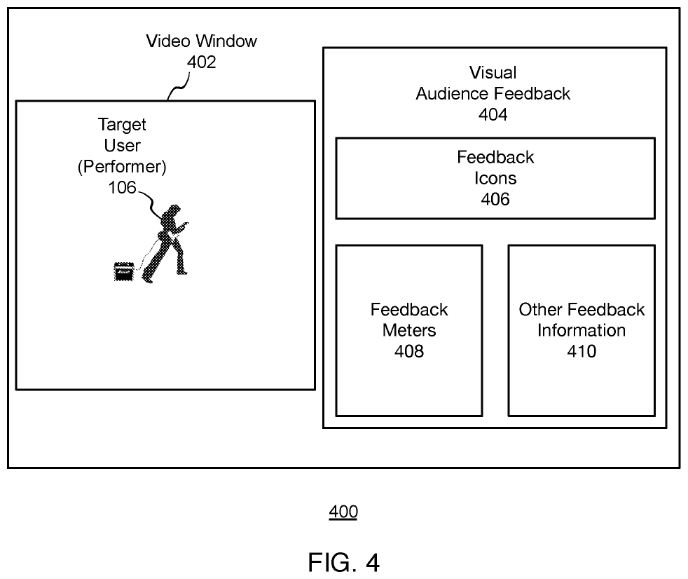

After system 102 generates the simulated audience feedback, system 102 provides the simulated audience feedback to the target client device. Various example embodiments directed to simulated audience feedback and audience feedback policies are described in more detail below. For example, FIG. 4 below illustrates an example user interface that displays various types of simulated audience feedback to target user 106.

Although the steps, operations, or computations may be presented in a specific order, the order may be changed in particular embodiments. Other orderings of the steps are possible, depending on the particular embodiment. In some particular embodiments, multiple steps shown as sequential in this specification may be performed at the same time. Also, some embodiments may not have all of the steps shown and/or may have other steps instead of, or in addition to, those shown herein.

FIG. 4 is an example user interface 400 for providing simulated audience feedback to a performer on camera, according to some implementations. User interface 400 enables system 102 to provide target user 106 with simulated audience feedback that represents the audience as a group. In other words, the simulated audience feedback provides combined audience feedback, which provides a simulated, collective group social signal.

As shown, user interface 400 includes a video window 402 for enabling target user 106 to view the performance. User interface 400 also displays visual audience feedback 404, which includes feedback icons 406, feedback meters 408, and other feedback information 410. In various embodiments, feedback icons 406 may include emoji streams or other visual effects (e.g., sparkles, balloons, etc.).

In various embodiments, feedback meters 408 may be visual indicators showing various audience feedback values. The types of audience feedback values and corresponding feedback meters may vary and depend on the particular implementation. For example, a given feedback meter may show an applause value. In another example, a given feedback meter may show a laughter value. In another example, a given feedback meter may show a booing value. In various embodiments, feedback meters 408 display one or more representations of the overall audience reaction ranging from bad to good, for example.

As indicated herein, some audience feedback may be positive and some audience feedback may be negative. In some embodiments, system 102 may provide color coded indicters to quickly and conveniently convey the sentiment to target user 106. For example, a feedback meter may show green in some form if associated with laughter. In another example, a feedback meter may show red in some form if associated with booing. The form of the colors may vary and depend on the particular implementation. For example, a particular color may be used on a bar graph, for letters, etc. In some embodiments, system 102 may also indicate a number or percentage of audience members who stop their live feed and do not reconnect to indicated how many people stop viewing the performance.

In various embodiments, other feedback information 410 may include any other feedback useful to target user 106. For example, as mentioned above, user interface 400 enables system 102 to provide target user 106 with simulated audience feedback that represents the audience as a group. In some embodiments, system 102 may also enable some individual feedback to be included in simulated audience feedback. For example, the other feedback information 410 may include a chat window that displays individual comments, etc.

In various embodiments, system 102 may provide auditory audience feedback to target user 106 via one or more audio speakers (not shown) that output various audio feedback such as applause, laughter, etc. In some embodiments, system 102 may also provide haptic audience feedback to target user 106 via one or more haptic devices (not shown) that output various haptic feedback such as vibrations, pulses, etc.

The follow descriptions detail further example embodiments that may be used in combination with other embodiments described herein.

As indicated herein, system 102 provides simulated audience feedback that represents audience reactions in real-time at different moments in a performance. In various embodiments, system 102 interprets raw audience feedback and converts such feedback to simulated audience feedback. The form may change in various ways. For example, in some examples described herein, system 102 may aggregate laughter sounds from multiple client devices and mix the laughter sounds together to provide sound that represents a group of audience members laughing together. In another example, system 102 may convert an auditory sound (e.g., laughter, etc.) or visual body language (e.g., a smile, etc.) to text (e.g., “I love this!,” etc.) or to a emoji (e.g., a heart, etc.).

In various embodiments, a predetermined audience feedback policy may be for system 102 to generate and output different simulated audience feedback based on the context. For example, in an entertainment context, system 102 may generate and output simulated audience feedback associated with laughter. In a business context, system 102 may generate and output simulated audience feedback associated with questions. For example, a public speaker may desire to view questions from the audience in order to answer some of the questions during a presentation. In various embodiments, system 102 may enable target user 106 to indicate the context to the system with button selections (e.g., “Entertainment,” “Comedy,” “Business,” etc.). In some embodiments, system 102 may also use artificial intelligence and machine learning to determine the context.

In various embodiments, a predetermined audience feedback policy may be to interpret social cues in raw audience feedback based on context and to provide at least some simulated audience feedback based on that context. For example, in various embodiments, system 102 may generate and output different simulated audience feedback based on the context. For example, in a entertainment context, system 102 may generate and output simulated audience feedback associated with laughter. In a business context, system 102 may generate and output simulated audience feedback associated with questions. For example, a public speaker may desired to view question from the audience in order to answer some of the questions during a presentation. In various embodiments, system 102 may enable target user 106 to indicate the context to the system with button selections (e.g., “Entertainment,” “Comedy,” “Business,” etc.). In some embodiments, system 102 may also use artificial intelligence and machine learning to determine the context.

In various embodiments, a predetermined audience feedback policy may be to interpret social cues in raw audience feedback in an international context and to provide at least some simulated audience feedback based on the international context. In an example scenario, in a business meeting between US and Japanese employees, Japanese silence may be interpreted as thinking. As such, system 102 may display appropriate simulated audience feedback (e.g., text that states, “Hm . . . ,” an emoji scratching its head, etc. In another example, stretching may be interpreted as boredom. As such, system 102 may display an emoji with frowny face, etc.).

In various embodiments, a predetermined audience feedback policy may be process to interpret social cues in raw audience feedback in the context of the target user and to provide at least some simulated audience feedback based on the target user. For example, in some embodiments, system 102 may detect and provide appropriate feedback to target user 106 based on the target user 106 (independent of any actual audience reaction). Such simulated audience feedback may include various types of feedback (e.g., tone, volume, etc.). In some embodiments, system 102 may apply filters and/or features at system 102. In various embodiments, such feedback about the target user 106 may be included with the simulated audience feedback. In some embodiments, system 102 may enable filters and/or features to be applied at the audience user level. For example, system 102 may enable audience client devices (e.g., computers, smart phones, televisions, etc.) to detect and provide appropriate feedback to target user 106 based on the tone of the target user 106 (independent of any actual audience reaction).

As indicated above, system 102 generates simulated audience feedback based at least in part on the characterizing raw audience feedback. In various embodiments, the system aggregates the raw audience feedback received from different audience client devices. The system then characterizes the raw audience feedback. For example, in various embodiments, system 102 may use artificial intelligence and machine learning to identify and categorize sounds such as chuckles, laughter, applause, boos, etc. System 102 may also determine the volume and duration of sounds in order to measure the intensity levels of these aspects.

In another example, in various embodiments, system 102 may use artificial intelligence and machine learning to identify and categorize body language such as leaning forward, smiling, frowning, etc. System 102 may also determine the duration and amplitude of different movements in order to measure the intensity levels of these aspects.

In some embodiments, system 102 may track incremental changes in the raw audience feedback in order to detect trends during the live event (higher or lower volume, higher or lower number of people, etc.). As such, system 102 provides simulated audience feedback based on actual audience reactions, which may indicate the magnitude of audience reactions). In other words, the outputted simulated audience feedback is proportional to the inputted raw audience feedback. The simulated audience feedback allows the performer to understand the impact their performance on the audience.

As indicated above, the intensity level of audience reactions may be subtle or at least less than the intensity level of audience reactions from audience members who are physically present at the performance. For example, a chuckle or laugh by someone at home could be at a lower intensity (e.g., volume, duration, etc.) than if that person were physically at the live event with many others.

In some embodiments, a predetermined audience feedback policy may be for system 102 to characterize a particular aspect of audience feedback such as laughter, measure an intensity level (e.g., volume, duration, etc.), and generate simulated audience feedback if and when the intensity level reaches a predefined threshold level. In various embodiments, system 102 may hold off providing certain feedback to target user 106 until one or more predefined threshold levels are reached. As a result, even if audience feedback is at a generally low volume level due to the nature of online performance experiences, system 102 may still provide target user 106 with useful, meaningful audience feedback in the form of simulated audience feedback.

In various embodiments, system 102 may limit or normalize the audio level of crowd reactions in the simulated audience feedback so that the sound simulating the audience crowd does not overpower the sound of the target user/performer. In some embodiments, a predetermined audience feedback policy may be for system 102 to mix sounds and set volumes based on the type of feedback. For example, system 102 may mix in laughter at a lower volume than clapping or cheering, etc. In another example, system 102 may add reverb could to clapping and/of cheering to make the sound more immersive.

In various embodiments, system 102 provides simulated audience feedback to the target client device based on the raw audience feedback and the one or more predetermined audience feedback policies described herein. In various embodiments, the simulated audience feedback provides artists/performers (e.g., musicians, live comedians, etc.) with reliable in-the-moment audience feedback to tailor their performance as desired. For example, in some scenarios, if a performer tells a specific joke that previously resulted in much laughter in one city (e.g., San Francisco), the joke might not result in a positive feedback in another city (e.g., Atlanta). In a live scenario, the performer may decide to skip similar jokes for the remainder of that performance based on the lack of positive feedback. The simulated audience feedback may inform the target user/performer to add and/or remove particular material as desired.

In various embodiments, the simulated audience feedback comprises one or more of visual audience feedback, auditory audience feedback, and haptic audience feedback. In various embodiments, the visual audience feedback may include visual signals (e.g., audience-selected emoji, stream of applause, etc.). In various embodiments, the auditory audience feedback may include clapping, cheering, etc., which may create a more visceral feeling and/or audience feedback.

In various embodiments, at least one predetermined audience feedback policy of the one or more predetermined audience feedback policies comprises characterizing positive and negative aspects of the raw audience feedback. In various embodiments, at least one predetermined audience feedback policy includes characterizing contextual information associated with the video.

In various embodiments, system 102 sends the simulated audience feedback only to the performer. Alternatively, in some embodiments, system 102 may also provide one or more portions of the simulated audience feedback to audience members via their respective audience client devices based on the one or more predetermined audience feedback policies. In various embodiments, the audience client devices provide the one or more portions of the simulated audience feedback to audience users.

System 102 may enable target user 106 to select whether to provide simulated audience feedback to audience members or not. System 102 may also enable target user 106 to select what types of simulated audience feedback to provide to audience members. For example, target user 106 may select certain sound feedback such as laughter to be heard by the audience. In some embodiments, the system may mix an aggregate of laughing sounds to be included in the simulated audience feedback to audience members. In some embodiments, the system may simply include a prerecorded laugh track in the simulated audience feedback to audience members.

In various embodiments, system 102 sends simulated audience feedback to target user 106 in a separate and independent process from sending simulated audience feedback to audience members. This is because the simulated audience feedback is more inclusive for target user 106. For example, feedback meters are useful for performers but probably not for audience members. Also, an audio of laughter may enhance the viewing experience for audience members. Such audio may be helpful to some performers such as comedians but may be distracting for other performers.

Embodiments described herein provide various benefits. For example, embodiments provide a target user/performer with useful audience feedback to enable the performer to modify a performance as desired based on the feedback. Embodiments described herein also provide different types of feedback including feedback icons, feedback meters, and other feedback information in order to provide more meaningful feedback to the target user.

Embodiments described herein avoid shortcomings of conventional solutions. For example, conventional solutions may include muting all participants. This can result in awkward silence. Also, the audience may have a harder time enjoying the performer if the performer cannot adjust to audience reaction. Some conventional solutions may provide an open mic for all participants, where the performer and audience members have equal stage time. This can result in interruptions, lack of privacy, and irrelevant details being shared (e.g., background conversations, etc.). Some conventional solutions may provide a partial open mic or limited open mic, where certain key members have the mic. This may result in audience members feeling uncomfortable when their individual contributions (e.g., loud laughs, etc.) are heard individually and are identifiable. Other audience members may lack the feeling of participation and group connection, as crowd sounds may feel sparse or inauthentic. Embodiments described herein avoid these challenges by the system providing simulated audience feedback to the target user/performer.

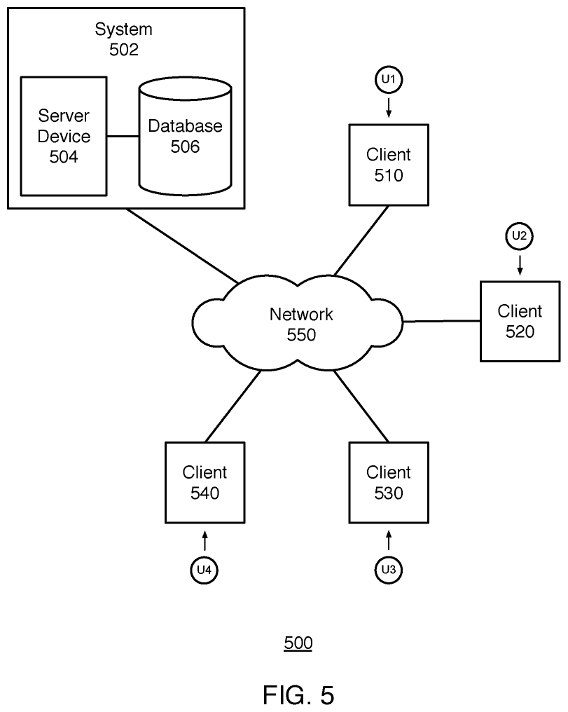

FIG. 5 is a block diagram of an example network environment 500, which may be used for some implementations described herein. In some implementations, network environment 500 includes a system 502, which includes a server device 504 and a database 506. For example, system 502 may be used to implement system 102 of FIG. 1, as well as to perform embodiments described herein. Network environment 500 also includes client devices 510, 520, 530, and 540, which may communicate with system 502 and/or may communicate with each other directly or via system 502. Network environment 500 also includes a network 550 through which system 502 and client devices 510, 520, 530, and 540 communicate. Network 550 may be any suitable communication network such as a Wi-Fi network, Bluetooth network, the Internet, etc.

For ease of illustration, FIG. 5 shows one block for each of system 502, server device 504, and network database 506, and shows four blocks for client devices 510, 520, 530, and 540. Blocks 502, 504, and 506 may represent multiple systems, server devices, and network databases. Also, there may be any number of client devices. In other implementations, environment 500 may not have all of the components shown and/or may have other elements including other types of elements instead of, or in addition to, those shown herein.

While server device 504 of system 502 performs embodiments described herein, in other embodiments, any suitable component or combination of components associated with system 502 or any suitable processor or processors associated with system 502 may facilitate performing the embodiments described herein.

In the various embodiments described herein, a processor of system 502 and/or a processor of any client device 510, 520, 530, and 540 cause the elements described herein (e.g., information, etc.) to be displayed in a user interface on one or more display screens.

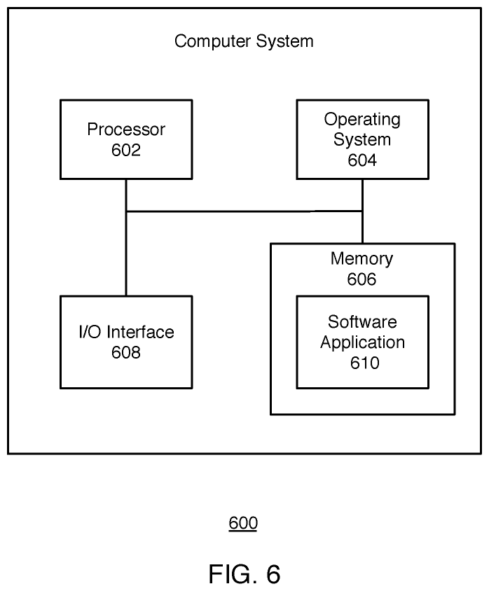

FIG. 6 is a block diagram of an example computer system 600, which may be used for some implementations described herein. For example, computer system 600 may be used to implement server device 504 of FIG. 5 and/or system 102 of FIG. 1, as well as to perform embodiments described herein. In some implementations, computer system 600 may include a processor 602, an operating system 604, a memory 606, and an input/output (I/O) interface 608. In various implementations, processor 602 may be used to implement various functions and features described herein, as well as to perform the method implementations described herein. While processor 602 is described as performing implementations described herein, any suitable component or combination of components of computer system 600 or any suitable processor or processors associated with computer system 600 or any suitable system may perform the steps described. Implementations described herein may be carried out on a user device, on a server, or a combination of both.

Computer system 600 also includes a software application 610, which may be stored on memory 606 or on any other suitable storage location or computer-readable medium. Software application 610 provides instructions that enable processor 602 to perform the implementations described herein and other functions. Software application may also include an engine such as a network engine for performing various functions associated with one or more networks and network communications. The components of computer system 600 may be implemented by one or more processors or any combination of hardware devices, as well as any combination of hardware, software, firmware, etc.

For ease of illustration, FIG. 6 shows one block for each of processor 602, operating system 604, memory 606, I/O interface 608, and software application 610. These blocks 602, 604, 606, 608, and 610 may represent multiple processors, operating systems, memories, I/O interfaces, and software applications. In various implementations, computer system 600 may not have all of the components shown and/or may have other elements including other types of components instead of, or in addition to, those shown herein.

Although the description has been described with respect to particular embodiments thereof, these particular embodiments are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a non-transitory computer-readable storage medium (also referred to as a machine-readable storage medium) for use by or in connection with the instruction execution system, apparatus, or device. Particular embodiments can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

Particular embodiments may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular embodiments can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A system comprising:
one or more processors; and
logic encoded in one or more non-transitory computer-readable storage media for execution by the one or more processors and when executed operable to cause the one or more processors to perform operations comprising:
receiving a video of a target user from a target client device;
providing the video to a plurality of audience client devices;
receiving raw audience feedback from the plurality of audience client devices;
determining an intensity level of the raw audience feedback; and
providing simulated audience feedback to the target client device based on the intensity level of the raw audience feedback and based on one or more predetermined audience feedback policies, wherein the target client device provides the simulated audience feedback to the target user.

2. The system of claim 1, wherein the logic when executed is further operable to cause the one or more processors to perform operations comprising:
aggregating the raw audience feedback;
characterizing the raw audience feedback; and
generating the simulated audience feedback based on the characterizing of the raw audience feedback and the one or more predetermined audience feedback policies.

3. The system of claim 1, wherein the logic when executed is further operable to cause the one or more processors to perform operations comprising providing simulated audience feedback to the target client device based on the raw audience feedback and the one or more predetermined audience feedback policies.

4. The system of claim 1, wherein the simulated audience feedback comprises one or more of visual audience feedback, auditory audience feedback, and haptic audience feedback.

5. The system of claim 1, wherein at least one predetermined audience feedback policy of the one or more predetermined audience feedback policies comprises characterizing positive and negative aspects of the raw audience feedback.

6. The system of claim 1, wherein at least one predetermined audience feedback policy of the one or more predetermined audience feedback policies comprises characterizing contextual information associated with the video.

7. The system of claim 1, wherein the logic when executed is further operable to cause the one or more processors to perform operations comprising providing one or more portions of the simulated audience feedback to the audience client devices based on the one or more predetermined audience feedback policies, wherein the audience client devices provide the one or more portions of the simulated audience feedback to audience users.

8. A non-transitory computer-readable storage medium with program instructions stored thereon, the program instructions when executed by one or more processors are operable to cause the one or more processors to perform operations comprising:
receiving a video of a target user from a target client device;
providing the video to a plurality of audience client devices;
receiving raw audience feedback from the plurality of audience client devices; and
determining an intensity level of the raw audience feedback; and
providing simulated audience feedback to the target client device based on the intensity level of the raw audience feedback and based on one or more predetermined audience feedback policies, wherein the target client device provides the simulated audience feedback to the target user.

9. The computer-readable storage medium of claim 8, wherein the instructions when executed are further operable to cause the one or more processors to perform operations comprising:
aggregating the raw audience feedback;
characterizing the raw audience feedback; and
generating the simulated audience feedback based on the characterizing of the raw audience feedback and the one or more predetermined audience feedback policies.

10. The computer-readable storage medium of claim 8, wherein the instructions when executed are further operable to cause the one or more processors to perform operations comprising providing simulated audience feedback to the target client device based on the raw audience feedback and the one or more predetermined audience feedback policies.

11. The computer-readable storage medium of claim 8, wherein the simulated audience feedback comprises one or more of visual audience feedback, auditory audience feedback, and haptic audience feedback.

12. The computer-readable storage medium of claim 8, wherein at least one predetermined audience feedback policy of the one or more predetermined audience feedback policies comprises characterizing positive and negative aspects of the raw audience feedback.

13. The computer-readable storage medium of claim 8, wherein at least one predetermined audience feedback policy of the one or more predetermined audience feedback policies comprises characterizing contextual information associated with the video.

14. The computer-readable storage medium of claim 8, wherein the instructions when executed are further operable to cause the one or more processors to perform operations comprising providing one or more portions of the simulated audience feedback to the audience client devices based on the one or more predetermined audience feedback policies, wherein the audience client devices provide the one or more portions of the simulated audience feedback to audience users.

15. A computer-implemented method comprising:
receiving a video of a target user from a target client device;
providing the video to a plurality of audience client devices;
receiving raw audience feedback from the plurality of audience client devices; and
determining an intensity level of the raw audience feedback; and
providing simulated audience feedback to the target client device based on the intensity level of the raw audience feedback and based on one or more predetermined audience feedback policies, wherein the target client device provides the simulated audience feedback to the target user.

16. The method of claim 15, further comprising:
aggregating the raw audience feedback;
characterizing the raw audience feedback; and
generating the simulated audience feedback based on the characterizing of the raw audience feedback and the one or more predetermined audience feedback policies.

17. The method of claim 15, further comprising providing simulated audience feedback to the target client device based on the raw audience feedback and the one or more predetermined audience feedback policies.

18. The method of claim 15, wherein the simulated audience feedback comprises one or more of visual audience feedback, auditory audience feedback, and haptic audience feedback.

19. The method of claim 15, wherein at least one predetermined audience feedback policy of the one or more predetermined audience feedback policies comprises characterizing positive and negative aspects of the raw audience feedback.

20. The method of claim 15, wherein at least one predetermined audience feedback policy of the one or more predetermined audience feedback policies comprises characterizing contextual information associated with the video.
